(19) United States
(12) Patent Application Publication
(10) Pub. No.: US 2025/0387992 A1
(43) Pub. Date: Dec. 25, 2025

(54) PRESS MACHINE AND METHOD OF DETECTING ABNORMALITY IN PRESS MACHINE

(71) Applicant: AIDA ENGINEERING, LTD., Kanagawa (JP)

(72) Inventor: Yoshiki YANAGIHARA, Sagamihara-shi (JP)

(21) Appl. No.: 19/244,099

(22) Filed: Jun. 20, 2025

(30) Foreign Application Priority Data
Jun. 21, 2024 (JP) 2024-100321

(51) Int. Cl. B30B 15/00

(52) U.S. Cl. CPC B30B 15/0094

(57) ABSTRACT

A press machine includes: a detection unit that detects a load value during press working on a workpiece material; a storage unit that stores load values for one cycle of the press machine detected by the detection unit in association with identification information of a die attached to the press machine during detection of the load values; a calculation unit that calculates eccentric loads for predetermined press angles based on the stored load values for one cycle of the press machine and generates eccentric load distribution data for each die; a determination unit that determines an abnormality based on the eccentric loads for the predetermined press angles obtained based on the load values for one cycle of the press machine detected by the detection unit and the eccentric load distribution data corresponding to a die attached to the press machine during the detection of the load values; and a notification unit that notifies of the abnormality based on a determination result of the determination unit.

### CROSS-REFERENCE TO RELATED APPLICATION

This application claims priority to Japanese Patent Application No. 2024-100321, filed on Jun. 21, 2024, the disclosure of which is hereby incorporated by reference in its entirety.

### BACKGROUND OF THE INVENTION

The present invention relates to a press machine and an abnormality detection method for a press machine.

Conventionally, there is a known method of calculating an eccentric amount (an eccentric position) from left and right load values when a total load value, which is a sum of the left and right load values in one press cycle, indicates a peak value, and detecting an abnormality when the eccentric load exceeds a range of an allowable eccentric load diagram (see JP 2016-209887 A).

With the conventional method described above, it is not possible to detect an abnormality based on the eccentric load when the total load value does not indicate the peak value. For example, in the progressive press working and the transfer press working, the working contents differ at each stage. Thus, the load at each stage does not necessarily occur at the same timing. With the conventional method, it is possible to detect the abnormality in the working (process) in the stage where the peak load occurs, but it is not possible to detect the abnormality in the working in the other stages.

In addition, the conventional method is a function for protecting the press machine. On the other hand, a user of a press machine needs to manage the condition of a die and the accuracy of pressed products in addition to the press protection, and take early action when a die abnormality or a product accuracy defect occurs. Since the abnormality in the die and the product accuracy are mainly a phenomenon that occurs within a range of the allowable eccentric load diagram, it is difficult to detect the die abnormality and the product accuracy defect using the conventional method.

### SUMMARY OF THE INVENTION

The present invention can provide a press machine and an abnormality detection method for a press machine that are capable of detecting a die abnormality in a plurality of processes.

According to a first aspect of the present invention, there is provided a press machine including:
a detection unit that detects a load value during press working on a workpiece material;
a storage unit that stores load values for one cycle of the press machine detected by the detection unit in association with identification information of a die attached to the press machine during detection of the load values;
a calculation unit that calculates eccentric loads for predetermined press angles based on the stored load values for one cycle of the press machine and generates eccentric load distribution data for each die;
a determination unit that determines an abnormality based on the eccentric loads for the predetermined press angles obtained based on the load values for one cycle of the press machine detected by the detection unit and the eccentric load distribution data corresponding to a die attached to the press machine during the detection of the load values; and
a notification unit that notifies of the abnormality based on a determination result of the determination unit.

According to a second aspect of the present invention, there is provided an abnormality detection method for a press machine, the method including:
a detection step of detecting a load value during press working on a workpiece material;
a storage step of storing load values for one cycle of the press machine detected by the detection step in association with identification information of a die attached to the press machine during detection of the load values;
a calculation step of calculating eccentric loads for predetermined press angles based on the stored load values for one cycle of the press machine and generating eccentric load distribution data for each die;
a determination step of determining an abnormality based on the eccentric loads for the predetermined press angles obtained based on the load values for one cycle of the press machine detected by the detection step and the eccentric load distribution data corresponding to a die attached to the press machine during the detection of the load values; and
a notification step of notifying the abnormality based on a determination result of the determination step.

### BRIEF DESCRIPTION OF THE DRAWINGS

FIG. 1 illustrates an example of a configuration of a press machine according to an embodiment of the present invention.

FIG. 2 illustrates an example of a load sensor.

FIG. 3 is a flowchart of Example 1 illustrating a flow of processing for generating eccentric load distribution data.

FIG. 4 illustrates an example of stored load values.

FIG. 5 illustrates an example of an eccentric load for each predetermined crank angle calculated from the load values for one shot.

FIG. 6 illustrates an example of eccentric load distribution data corresponding to the selected die numbers.

FIG. 7 illustrates an example of average data of eccentric loads.

FIG. 8 is a flowchart of Example 2 illustrating a flow of processing for generating eccentric load distribution data.

FIG. 9 illustrates an example of the eccentric load distribution data and data indicating a normal range based on machine learning.

FIG. 10 is a flowchart of Example 1 illustrating a flow of processing for detecting an abnormality.

FIG. 11 illustrates an example of average data of eccentric loads and detection data.

FIG. 12 is a flowchart of Example 2 illustrating a flow of processing for detecting an abnormality.

FIG. 13 illustrates an example of a total load value corresponding to a crank angle and a left/right load difference.

FIG. 14 illustrates an example of a timing at which a load occurs in a progressive press working.

FIG. 15 illustrates an example of a three-dimensional display of an eccentric load for each predetermined crank angle calculated from the load values for one shot.

### DETAILED DESCRIPTION OF THE INVENTION

(1) According to an embodiment of the present invention, there is provided a press machine including:
a detection unit that detects a load value during press working on a workpiece material;
a storage unit that stores load values for one cycle of the press machine detected by the detection unit in association with identification information of a die attached to the press machine during detection of the load values;
a calculation unit that calculates eccentric loads for predetermined press angles based on the stored load values for one cycle of the press machine and generates eccentric load distribution data for each die;
a determination unit that determines an abnormality based on the eccentric loads for the predetermined press angles obtained based on the load values for one cycle of the press machine detected by the detection unit and the eccentric load distribution data corresponding to a die attached to the press machine during the detection of the load values; and
a notification unit that notifies of the abnormality based on a determination result of the determination unit.

According to an embodiment of the invention, there is provided an abnormality detection method for a press machine, the method including:
a detection step of detecting a load value during press working on a workpiece material;
a storage step of storing load values for one cycle of the press machine detected by the detection step in association with identification information of a die attached to the press machine during detection of the load values;
a calculation step of calculating eccentric loads for predetermined press angles based on the stored load values for one cycle of the press machine and generating eccentric load distribution data for each die;
a determination step of determining an abnormality based on the eccentric loads for the predetermined press angles obtained based on the load values for one cycle of the press machine detected by the detection step and the eccentric load distribution data corresponding to a die attached to the press machine during the detection of the load values; and
a notification step of notifying the abnormality based on a determination result of the determination step.

According to the above embodiments, the detected load values for one cycle are stored in association with the identification information of the die attached to the press machine during the detection, the eccentric load for each press angle is calculated based on the stored load values for one cycle and the eccentric load distribution data for each die is generated, and the abnormality is determined based on the eccentric load for each press angle obtained based on the load values for one press cycle and the eccentric load distribution data corresponding to the die attached to the press machine during the detection of the load value. Thus, it is possible to detect a die abnormality in a plurality of processes.

(2) In the press machine according to the above embodiment,
the calculation unit may average the eccentric load distribution data to generate average data, and
the determination unit may determine the abnormality based on the eccentric loads for the predetermined press angles obtained based on the load values for one cycle of the press machine detected by the detection unit and the average data that corresponds to a die attached to the press machine during the detection of the load values.

In the abnormality detection method for the press machine according to the above embodiment,
in the calculation step,
the eccentric load distribution data may be averaged to generate average data, and
in the determination step,
the abnormality may be determined based on the eccentric loads for the predetermined press angles obtained based on the load values for one cycle of the press machine detected by the detection step and the average data that corresponds to a die attached to the press machine during the detection of the load values.

(3) In the press machine according to the above embodiment,
the calculation unit may generate normal range data for determining a normal range of the eccentric loads for the press angles using machine learning from the eccentric load distribution data, and
the determination unit may determine the abnormality based on the eccentric loads for the predetermined press angles obtained based on the load values for one cycle of the press machine detected by the detection unit and the normal range data of the eccentric loads for the press angles corresponding to a die attached to the press machine during the detection of the load values.

In the abnormality detection method according to the above embodiment,
in the calculation step,
normal range data for determining a normal range of the eccentric loads for the press angles may be generated using machine learning from the eccentric load distribution data, and
in the determination step,
the abnormality may be determined based on the eccentric loads for the predetermined press angles obtained based on the load values for one cycle of the press machine detected by the detection step and the normal range data of the eccentric loads for the press angles corresponding to a die attached to the press machine during the detection of the load values.

Some embodiments of the present invention will be described in detail below, with reference to the drawings.

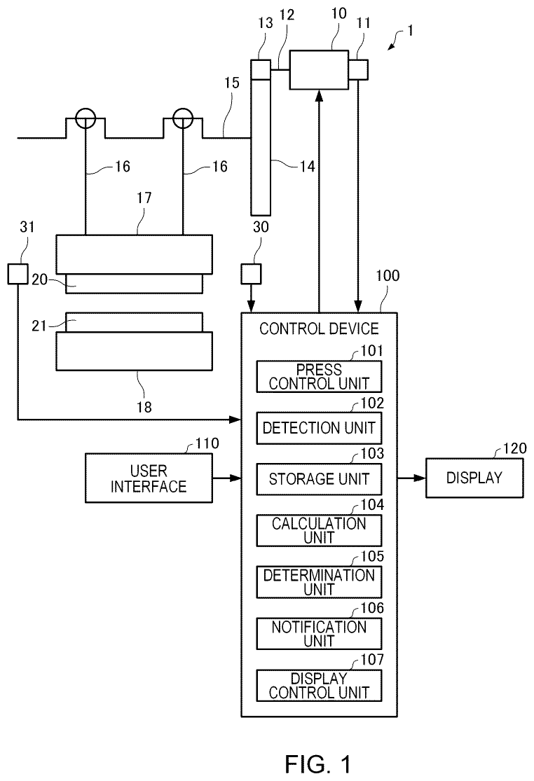

FIG. 1 illustrates an example of a configuration of a press machine (a servo press) according to an embodiment of the present application. A press machine 1 converts rotation of a servomotor 10 into a vertical reciprocating motion (a linear reciprocating motion, an elevating and lowering motion) of a slide 17 by an eccentric mechanism that converts a rotational motion into a linear motion, and performs a press working on a workpiece material using the vertical reciprocating motion of the slide 17. The press machine 1 includes the servomotor 10, an encoder 11, a drive shaft 12, a drive gear 13, a main gear 14, a crankshaft 15, a connecting rod 16, the slide 17, a bolster 18, a control device 100, a user interface 110 (an action unit), and a display 120 (a display unit). The press machine is not limited to a servo press, and may be, for example, a mechanical press using a flywheel.

The drive shaft 12 is connected to a rotating shaft of the servomotor 10, and the drive gear 13 is connected to the drive shaft 12. The main gear 14 is meshed with the drive gear 13, the crankshaft 15 is connected to the main gear 14, and the connecting rod 16 is connected to the crankshaft 15. Rotating shafts such as the drive shaft 12 and the crankshaft 15 are supported by bearings (not illustrated) appropriately provided. An eccentric mechanism is formed between the crankshaft 15 and the connecting rod 16. This eccentric mechanism allows the slide 17 connected to the connecting rod 16 to move upward and downward relative to the bolster 18 on a stationary side. Here, the press machine 1 is a two-point drive press machine in which the crankshaft 15 and the slide 17 are connected by two connecting rods 16 that also function as suspensions. An upper die 20 is attached to the slide 17, and a lower die 21 is attached to the bolster 18.

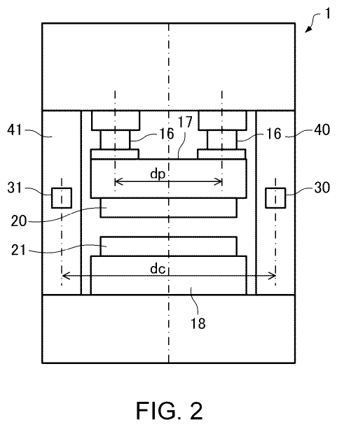

The press machine 1 includes a right load sensor 30 and a left load sensor 31 for detecting load values during press working on a workpiece material for each press cycle. As illustrated in FIG. 2, the right load sensor 30 is a strain gauge attached to a right column 40 (a right side frame) of the press machine 1, and the left load sensor 31 is a strain gauge attached to a left column 41 (a left side frame) of the press machine 1. When the eccentric load in the left/right direction and the eccentric load in the front/back direction of the press machine is determined, it is preferred to provide respective load sensors on four columns (not illustrated) at the front right, rear right, front left, and rear left. Note that, as the right load sensor 30 and the left load sensor 31, a pressure sensor provided in a hydraulic chamber formed in the slide 17 may be used. When using a pressure sensor with a four-point drive press machine, the pressure sensor is provided on each of the four hydraulic chambers at the front right, rear right, front left, and rear left. Output data of the right load sensor 30 and the left load sensor 31 (voltage signals of the strain gauge or the pressure sensor) are input to the control device 100.

The control device 100 includes a press control unit 101, a detection unit 102, a storage unit 103, a calculation unit 104, a determination unit 105, and a notification unit 106. The control device 100 may be divided into an independent device that controls the press machine, which is constituted of the press control unit 101, a display control unit 107, the user interface 110, and a display 120, and an independent load detection device, which is constituted of the detection unit 102, the storage unit 103, the calculation unit 104, the determination unit 105, the notification unit 106, the user interface 110, and the display 120. In this case, the output data of the right load sensor 30 and the left load sensor 31 are directly input to the load detection device. In addition, the operation information of the press machine, such as crank angle information, is input to the load detection device as necessary from the device that controls the press machine.

The detection unit 102 receives data output from the right load sensor 30 and data output from the left load sensor 31 for each press cycle, converts the received data based on calibration data stored in the storage unit 103, and detects the load values (a right load value and a left load value) during the press working. The calibration data indicates a relationship between the voltage signal and the load value, and is measured in advance using a load cell or the like and stored in the storage unit 103.

The storage unit 103 stores the load values for one press cycle detected by the detection unit 102 in association with the identification information (a die number) of the die (the upper die 20 and the lower die 21) attached to the slide 17 and the bolster 18 of the press machine 1 during the detection of the load values.

The calculation unit 104 calculates the eccentric load for each predetermined press angle based on the load values for one press cycle stored in the storage unit 103, and generates the eccentric load distribution data for each die. The press angle is an angle corresponding to a position of the slide 17 during one press cycle, and refers to the angle of the main shaft, such as the crankshaft or the eccentric shaft. In this embodiment, since the crankshaft is used, the press angle is referred to as the “crank angle” below. When calculating the eccentric load at an arbitrary crank angle, the position of the load center acting on the press machine 1 is calculated based on the load values (the right load value and the left load value) at the crank angle, the calculated load center position is calculated as the eccentric amount from the center of the press machine 1, and the eccentric load (a set of the total load value of the right load value and the left load value and the eccentric amount) at the crank angle is calculated. Here, the load center means the center of gravity of the load. In addition, the center of the press machine 1 means the center position of the slide 17 on a plane perpendicular to the direction (up and down direction) in which the slide 17 moves. In addition, the calculation unit 104 may generate average data (the average data for each die) by averaging the eccentric load distribution data.

The calculation unit 104 may further extract the eccentric load data for each crank angle from the eccentric load distribution data and may generate normal range data for the eccentric load for each of the crank angles using machine learning such as a one-class SVM (support vector machine) from the extracted eccentric load data. The normal range data is data generated to determine the identification boundary indicating the normal range, and is data that constitutes lines or planes for determining the normal range.

The determination unit 105 determines an abnormality based on the eccentric load for each crank angle calculated by the calculation unit 104 based on the load values for one press cycle detected by the detection unit 102 and the distribution data (or the average data) of the eccentric loads corresponding to the die attached to the slide 17 and the bolster 18 of the press machine 1 during the detection of the load value.

The notification unit 106 notifies of the abnormality based on the determination result of the determination unit 105. For example, when the abnormality is determined by the determination unit 105, the notification unit 106 outputs information to that effect to the display 120.

The user interface 110 is a known input means (for example, a mouse, a trackball, a keyboard, or the like) that allows an action on the display 120. Further, the user interface 110 may be provided integrally with the display 120. In this case, an input means is displayed on the display 120.

The display 120 is a liquid crystal display (LCD) screen. Other known display devices (for example, organic Electro Luminescence (EL) or the like) may be used as the display 120. Further, a touch panel type display may be used as the display 120. As the touch panel, a touch panel of a known type such as a resistive film type, a capacitance type, a surface type capacitance type, or a projection type capacitance type can be used. As long as the display is of the touch panel type, an input action is achieved by directly touching the display 120 with a finger or a pen.

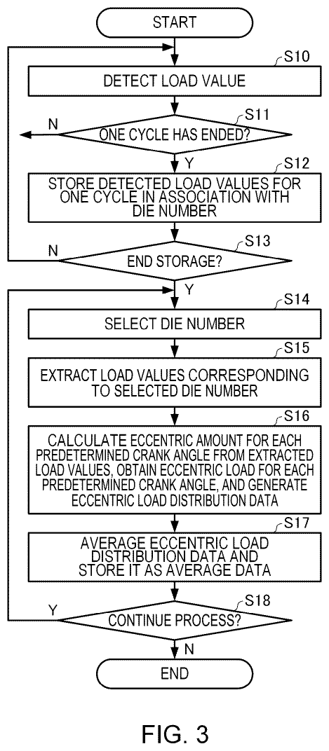

FIG. 3 is a flowchart illustrating a flow of processing for generating the eccentric load distribution data in Example 1.

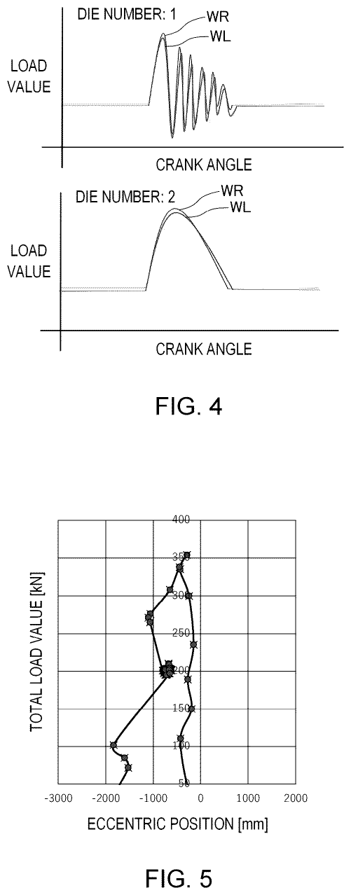

The processing in Steps S10 to S13 stores the load values. The load values are stored when a die is attached to the press machine 1 and a trial run (a die trial) is performed. First, the detection unit 102 receives the data output from the right load sensor 30 and the data output from the left load sensor 31, converts the received data based on the calibration data stored in the storage unit 103, and detects the converted data as the load values (Step S10). Next, the control device 100 determines whether or not one cycle of the press has ended based on information on the current crank angle (Step S11), and when the one cycle has not ended (No in Step S11), the processing proceeds to Step S10 and continues detecting the load values. When the one cycle is completed (Y in Step S11), the storage unit 103 stores the detected load values for the one cycle (waveform data of the right load and waveform data of the left load) in association with the die numbers of the dies attached to the slide 17 and the bolster 18 of the press machine 1 during the detection (Step S12). FIG. 4 illustrates an example of the stored load values. As illustrated in FIG. 4, load waveforms WR for one cycle detected based on the data from the right load sensor 30 and load waveforms WL for one cycle detected based on the data from the left load sensor 31 are stored as the load values in association with the die numbers. The load waveform for one cycle is, for example, the load values for each degree in the range of the crank angles of “0 to 359 degrees.” Next, the control device 100 determines whether or not to terminate the storage of the load values (Step S13), and when the storage is to be continued (N in Step S13), the processing proceeds to Step S10 and thereafter stores the load values for each press cycle.

The processing in Steps S14 to S18 generates the eccentric load distribution data. First, the control device 100 selects a die number based on an operation by a user on the user interface 110 (Step S14). Next, the calculation unit 104 extracts the load values corresponding to the selected die number from the stored load value data (Step S15), calculates the eccentric amount for each predetermined crank angle (for example, every one degree in the range of the crank angles of “0 to 359 degrees”) from the extracted load values (the load values for one cycle), obtains the eccentric load for each predetermined crank angle, and generates the eccentric load distribution data corresponding to the selected die number (Step S16). The eccentric amount (the eccentric position) at any crank angle can be calculated from the balance of moments based on the left and right load values at the crank angle and a distance between the right load sensor 30 and the left load sensor 31 (a distance dc illustrated in FIG. 2). The eccentric amount is positive when the right load is greater than the left load, negative when the left load is greater than the right load, and an absolute value thereof increases as the difference between the left and the right loads increases. In addition, the eccentric load at an arbitrary crank angle is a set of data including the total value of the left and right load values at the crank angle (the total load value) and the eccentric amount calculated from the left and right load values. When pressure sensors provided in hydraulic chambers formed in the slide 17 are used as the right load sensor 30 and the left load sensor 31, the eccentric amount can be calculated based on the left and right load values and the distance between the two connecting rods 16 (a point interval, a distance dp illustrated in FIG. 2).

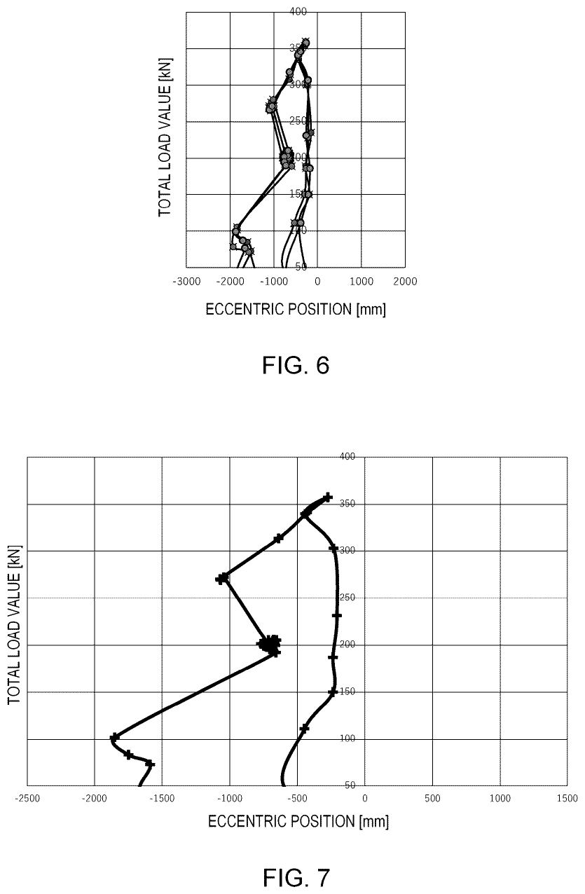

FIG. 5 illustrates an example of the eccentric load for each predetermined crank angle calculated from the load values for one shot. The graphs in FIGS. 5 and 6 illustrate the eccentric load plotted for each crank angle of one degree, with the eccentric position (unit: mm) on the horizontal axis and the total load value (unit: kN) on the vertical axis. The filled point in the figures indicates a single piece of eccentric load data, and the eccentric loads for adjacent crank angles are connected by a line. FIG. 6 is an example of the eccentric load distribution data corresponding to the selected die number, and the eccentric load for each predetermined crank angle calculated from the respective load values of a plurality of shots (three shots in this case) of the same extracted die are plotted.

Next, the calculation unit 104 stores the data generated by averaging the distribution data of the generated eccentric loads as the average data corresponding to the selected die number in the storage unit 103 (Step S17). FIG. 7 illustrates the average data generated by averaging the respective eccentric loads at the same crank angle in the eccentric load distribution data illustrated in FIG. 6.

Next, the control device 100 determines whether to continue the processing (the generation of the distribution data and the average data or the normal range data of the eccentric loads corresponding to another die number) (Step S18), and when the processing is to be continued (Y in Step S18), the processing proceeds to Step S14.

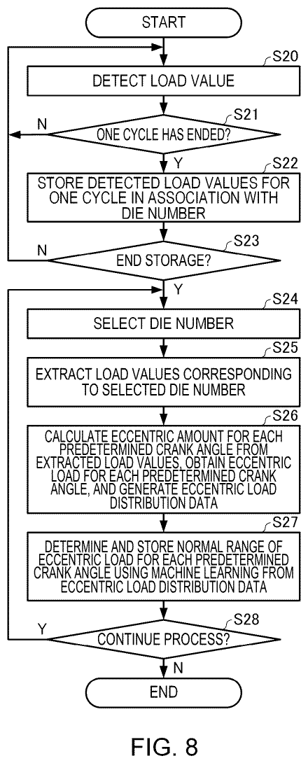

FIG. 8 is a flowchart illustrating a flow of processing for generating the eccentric load distribution data in Example 2. As in Example 1, the load values are stored when the die is attached to the press machine 1 and the test run is performed. Step S20 to Step S26 are omitted because they are the same as in Example 1.

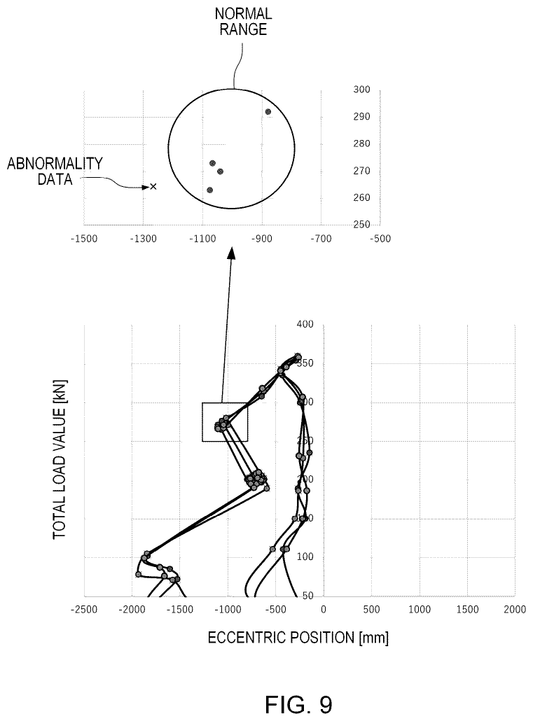

The calculation unit 104 extracts the eccentric load data for each predetermined crank angle from the eccentric load distribution data, generates the data for determining the identification boundary indicating the normal ranges of the eccentric load for each predetermined crank angle from the extracted eccentric load data using the machine learning, and stores them as the data indicating the normal range of the eccentric load for each predetermined crank angle corresponding to the selected die number in the storage unit 103 (Step S27). FIG. 9 illustrates an example of the normal range obtained using the machine learning from the data of the plurality of eccentric loads at a certain crank angle in the eccentric load distribution data, and the data within the normal range and the data outside the normal range (abnormal data).

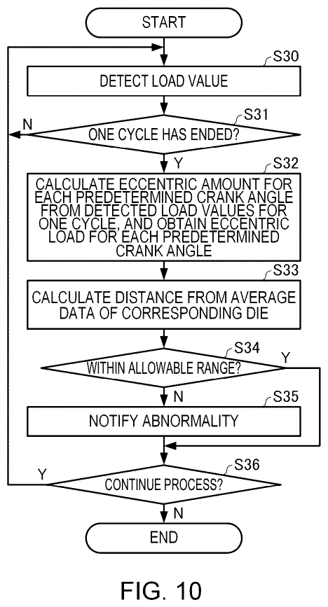

FIG. 10 is a flowchart illustrating a flow of processing for detecting the abnormality in Example 1. The abnormality is detected during a normal press operation.

First, the detection unit 102 receives the data output from the right load sensor 30 and the data output from the left load sensor 31, converts the received data based on the calibration data stored in the storage unit 103, and detects the converted data as the load values (Step S30). Next, the control device 100 determines whether or not one cycle of the press has ended based on information on the current crank angle (Step S31), and when the one cycle has not ended (N in Step S31), the processing proceeds to Step S30 and continues detecting the load values. When the one cycle is completed (Y in Step S31), the calculation unit 104 calculates the eccentric amount for each predetermined crank angle from the detected load values for one cycle (the waveform data of the right load and the waveform data of the left load) and obtains the eccentric load for each predetermined crank angle (Step S32).

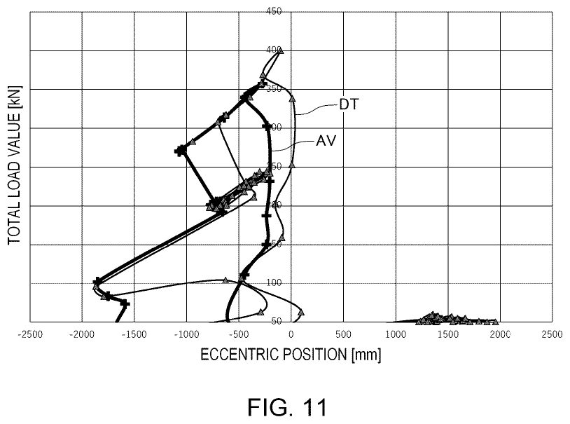

Next, the determination unit 105 acquires the average data corresponding to the die number of the die attached to the slide 17 and the bolster 18 of the press machine 1 during the detection of the load value in Step S30 from the average data for each die stored in the storage unit 103, and calculates the distance between the eccentric load for each predetermined crank angle obtained in Step S32 and the acquired average data (Step S33), and determines whether or not the distance is within a predetermined allowable range (Step S34). When the distance exceeds the allowable range (N in Step S34), the notification unit 106 notifies of the abnormality (Step S35). For example, for the eccentric load at each predetermined crank angle of the average data and the eccentric load at each predetermined crank angle obtained in Step S32, the distance between the eccentric loads at the same crank angle (the distance on the xy plane with the eccentric amount as the x-axis and the total load value as the y-axis) is obtained, and the eccentric load for which the obtained distance exceeds the predetermined threshold value are determined as the abnormal points. When the number of the abnormal points is greater than or equal to a predetermined number, it may be determined that the allowable range has been exceeded. In addition, when the total value or the average value of the calculated distances exceeds the predetermined threshold value, it may be determined that the allowable range has been exceeded. FIG. 11 illustrates an example of the average data AV and the detection data DT (the eccentric load for each predetermined crank angle obtained in Step S32) when the abnormality is detected (the distance exceeds the allowable range). When calculating the distance between the average data AV and the detection data DT, it is also possible to use only the data for the eccentric loads whose total load values are greater than or equal to a predetermined value. In the example illustrated in FIG. 11, only the distances of the eccentric loads whose total load values are 50 kN or more are calculated from the average data AV and the detection data DT (the eccentric loads whose total load value are less than 50 kN are excluded). In addition, the distance between the average data AV and the detection data DT may be obtained using only the eccentric load data within a predetermined crank angle range (for example, a range of 180+n degrees).

Next, the control device 100 determines whether to continue the abnormality detection processing (Step S36), and when the processing is to be continued (Y in Step S36), the processing proceeds to Step S30 and thereafter detects the abnormality based on the eccentric loads obtained for each press cycle.

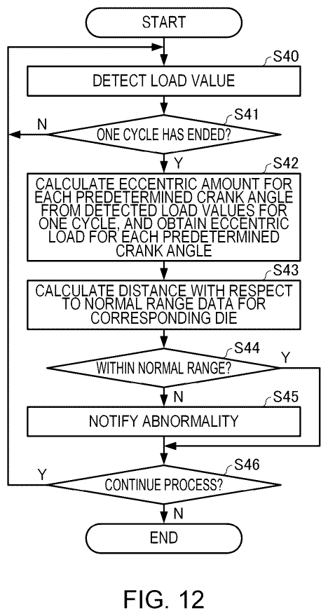

FIG. 12 is a flowchart illustrating a flow of processing for detecting the abnormality in Example 2. As in Example 1, the abnormality is detected during the normal press operation. Since Steps S40 to S42 are the same as in Example 1, their description is omitted.

The determination unit 105 acquires the data indicating the normal range of the eccentric load for each predetermined crank angle corresponding to the die number of the die attached to the slide 17 and the bolster 18 of the press machine 1 during the detection of the load value in Step S40 as the normal range data from the data indicating the normal range of the eccentric load for each die stored in the storage unit 103, obtains the distance (the position) of the eccentric load for each predetermined crank angle obtained in Step S42 from the normal range of the eccentric load for each predetermined crank angle (Step S43), and determines whether the distance (the position) of the eccentric load is within the normal range (Step S44). When the value falls outside the normal range (N in Step S44), the notification unit 106 notifies of the abnormality (Step S45).

Next, the control device 100 determines whether or not to continue the abnormality detection processing (Step S46), and when the processing is to be continued (Y in Step S46), the processing proceeds to Step S40, and thereafter detects the abnormality based on the eccentric load obtained for each press cycle and the data indicating the normal range of the eccentric load for each predetermined crank angle.

According to the present embodiment, the load values for one press cycle detected by the detection unit 102 are stored in advance in association with the die number of the die attached to the slide 17 and the bolster 18 of the press machine 1 during the detection of the load values, the eccentric load for each crank angle are calculated based on the stored load values for one press cycle, and the distribution data (the average data) of the eccentric load for each die are generated, the abnormality is determined based on the eccentric load for each crank angle calculated based on the load values for one press cycle detected by the detection unit 102 during the press operation and the eccentric load distribution data corresponding to the die attached to the slide 17 and the bolster 18 of the press machine 1 during the detection of the load values, it is possible to detect the abnormality in the die in a plurality of processes.

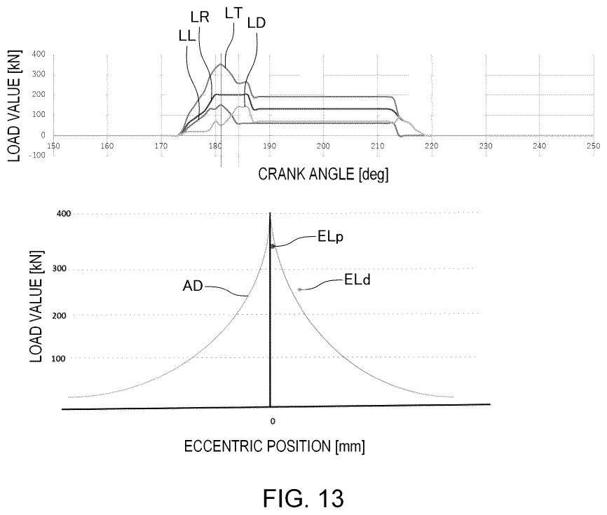

In the conventional art, since the eccentric load is calculated from the left and right load values when the total load value indicates the peak value to detect the abnormality, it is not possible to detect the abnormality based on the eccentric load when the total load value does not indicate the peak value. FIG. 13 illustrates an example of a total load value LT (a sum of the right load value LR and the left load value LL) and a left/right load difference LD (a difference between the right load value LR and the left load value LL) corresponding to the crank angle. It also illustrates the eccentric load ELp when the total load value LT indicates the peak value and the eccentric load ELd when the left/right load difference LD is at its maximum. In the example illustrated in FIG. 13, although the eccentric load ELd when the left/right load difference LD is at the maximum exceeds a range of the allowable eccentric load diagram AD, the eccentric load ELp when the total load value LT indicates the peak value is within the range of the allowable eccentric load diagram AD. Thus, the conventional art cannot detect the abnormality. On the other hand, in the present embodiment, it is possible to detect the abnormality when the distance between the eccentric load ELd and the eccentric load at the corresponding crank angle of the average data (or the distance between the eccentric load ELd and the normal range of the eccentric load at the corresponding crank angle) is sufficiently large.

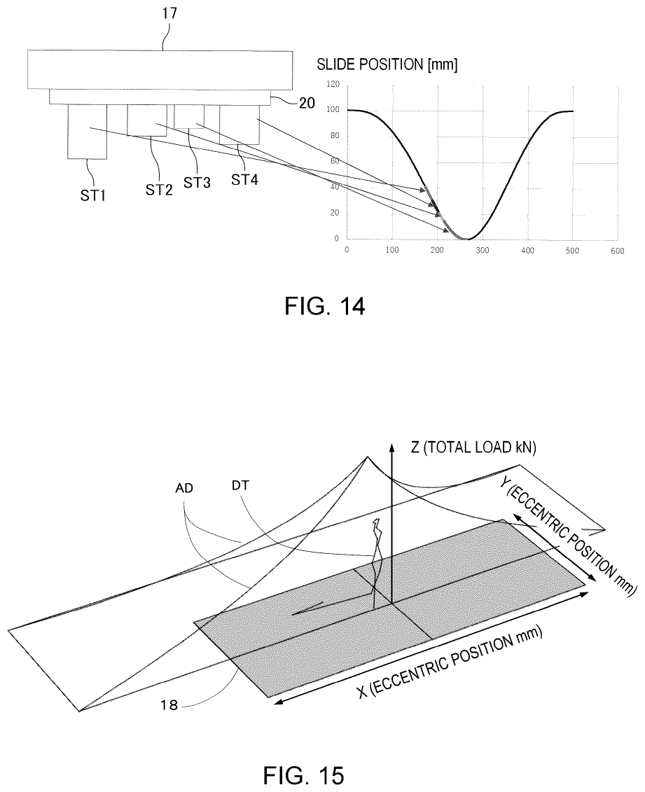

In addition, when the plurality of processes (stages) are performed with a single press machine, such as in the progressive press working or the transfer press working, since the working contents differ for each stage, the loads for each stage do not necessarily occur at the same timing. FIG. 14 illustrates an example of a timing of a load generation in the progressive press working. In this example, the working is performed in four stages ST1 to ST4, and when the slide 17 descends toward the bottom dead center, the loads are generated in the order of the stage ST1, the stage ST4, the stage ST2, and the stage ST3. In the conventional art, it is possible to detect the abnormality in the working in the stage at which the peak load occurs. However, it is not possible to detect the abnormality in the working in the other stages. On the other hand, in the present embodiment, calculating the eccentric load for each predetermined crank angle and performing the abnormality determination allows detecting the abnormality also in a process other than the process in which the peak load occurs.

Furthermore, the eccentric load distribution data acting on the press machine may be displayed in a three-dimensional graph. FIG. 15 illustrates an example of a three-dimensional graph. In this graph, the horizontal axes represent the eccentric position (unit: mm) from the center of the press machine in the left/right direction (X-axis) and the front/back direction (Y-axis), and the vertical axis (Z-axis) represents the total load value (unit: kN). The mountain-shaped curve illustrates the allowable eccentric load diagram AD. Compared with the two-dimensional displays, the three-dimensional displays make it easier for workers to see differences between the current detection data DT and the average data AV (a distribution in a normal state) that is not illustrated in the graph, thus allowing them to detect signs of trouble at an earlier stage.

A calculation method of creating an allowable load diagram (corresponding to the AD in FIG. 13) for a two-point drive press machine is disclosed in JP-A-2016-209887, but this method has been well known among persons skilled in the art for a long time. The allowable eccentric load diagram created using this calculation method is limited only by point capability, and does not take into account the effects of a slide inclination. The slide inclination occurs due to the rotational moment applied to the press machine by the eccentric load and a structure of the press machine that receives the rotational moment. For this reason, even when the press machine is used with a load within the allowable eccentric load value limited only by the point capability, there is a risk of problems such as deterioration of the product accuracy due to the slide inclination, the slide guide seizure, die damage, and even damage to the press machine frame and points. To avoid such problems, each press manufacturer creates and provides users with composite allowable load diagrams that take into account safety factors and slide inclination amounts, based on point capability limits. In addition, in a two-point drive press machine, when an eccentric load acts in the front/back direction of the slide, the slide behaves in the same way as a one-point drive press machine due to its structure, and a rotation occurs due to the rotational moment with the connection between the point and the slide as the fulcrum, causing the inclination. The amount of the inclination depends on the amount of the rotational moment and the structure of the press machine, such as the slide guide that receives the rotational moment. Therefore, the composite allowable load diagrams that take into account the safety factors and the slide inclination amounts are created and provided to the users, based on the point capability limit, for the allowable eccentric load in the front/back direction of the two-point drive press machine, as in the left/right direction.

Some embodiments of the present invention have been described in detail above, but a persons skilled in the art will readily appreciate that various modifications can be made from the embodiments without materially departing from the novel teachings and effects of the invention.

What is claimed is:

1. A press machine comprising:
a detection unit that detects a load value during press working on a workpiece material;
a storage unit that stores load values for one cycle of the press machine detected by the detection unit in association with identification information of a die attached to the press machine during detection of the load values;
a calculation unit that calculates eccentric loads for predetermined press angles based on the stored load values for one cycle of the press machine and generates eccentric load distribution data for each die;
a determination unit that determines an abnormality based on the eccentric loads for the predetermined press angles obtained based on the load values for one cycle of the press machine detected by the detection unit and the eccentric load distribution data corresponding to a die attached to the press machine during the detection of the load values; and
a notification unit that notifies of the abnormality based on a determination result of the determination unit.

2. The press machine according to claim 1,
wherein the calculation unit averages the eccentric load distribution data to generate average data, and
wherein the determination unit determines the abnormality based on the eccentric loads for the predetermined press angles obtained based on the load values for one cycle of the press machine detected by the detection unit and the average data that corresponds to the die attached to the press machine during the detection of the load values.

3. The press machine according to claim 1,
wherein the calculation unit generates normal range data for determining a normal range of the eccentric loads for the press angles using machine learning from the eccentric load distribution data, and
wherein the determination unit determines the abnormality based on the eccentric loads for the predetermined press angles obtained based on the load values for one cycle of the press machine detected by the detection unit and the normal range data of the eccentric loads for the press angles corresponding to the die attached to the press machine during the detection of the load values.

4. An abnormality detection method for a press machine, the method comprising:
a detection step of detecting a load value during press working on a workpiece material;
a storage step of storing load values for one cycle of the press machine detected by the detection step in association with identification information of a die attached to the press machine during detection of the load values;
a calculation step of calculating eccentric loads for predetermined press angles based on the stored load values for one cycle of the press machine and generating eccentric load distribution data for each die;
a determination step of determining an abnormality based on the eccentric loads for the predetermined press angles obtained based on the load values for one cycle of the press machine detected by the detection step and the eccentric load distribution data corresponding to a die attached to the press machine during the detection of the load values; and
a notification step of notifying the abnormality based on a determination result of the determination step.
